(19) United States
(12) Patent Application Publication
(10) Pub. No.: US 2010/0030816 A1
(43) Pub. Date: Feb. 4, 2010

(54) Bursting in a Content Management System

(75) Inventors: David Gerard Herbeck, Rochester, MN (US); John Edward Petri, Lewiston, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, Armonk, NY (US)

(21) Appl. No.: 12/183,113

(22) Filed: Jul. 31, 2008

(51) Int. Cl. G06F 17/30

(52) U.S. Cl. 707/201; 707/E17.01

(57) ABSTRACT

When a document is checked into a content management system repository, parts of the document may be stored as separate chunks in the repository based on bursting rules associated with that document. These chunks may be associated with chunk-specific bursting rules several levels deep. A granular bursting mechanism processes each chunk in the repository using the applicable bursting rule. One suitable implementation to determine the applicable bursting rule is to recursively decide whether to use the rules for the parent document, or the chunk-specific bursting rules. Another suitable implementation to determine the applicable bursting rule is for each chunk, to check the parent document's child processing policy. If the parent document's child processing policy allows specific rules to be overwritten, the chunk-specific bursting rules for the chunk are used. If the parent document's child processing policy does not allow rules to be overwritten, the parent document's bursting rules are used.

### BACKGROUND

1. Technical Field

This disclosure generally relates to content management systems, and more specifically relates to bursting in a content management system.

2. Background Art

A content management system (CMS) allows many users to efficiently share electronic content such as text, audio files, video files, pictures, graphics, etc. Content management systems typically control access to content in a repository. A user may generate content, and when the content is checked into the repository, the content may be subsequently processed by the CMS according to predefined rules. A user may also check out content from the repository, or link to content in the repository while generating content. The rules in a CMS assure that content that comes into or out of the system or that is linked to meets desired criteria specified in the rules.

Known content management systems check their rules when content comes into or out of the repository. If a rule is satisfied, the CMS may perform subsequent processing on the content. Known content management systems may include rules related to bursting, linking, and synchronization. Bursting rules govern how a document is bursted, or broken into individual chunks, when the document is imported or checked into the repository. By bursting a document into chunks, the individual chunks may be potentially reused later by a different author. Linking rules are used for importing and associating objects related to a CMS document based on particular elements or attributes from the document as specified by the rules. For example, an XML document that references external images can take advantage of linking rules so that relationships between the XML content and the external images are automatically created when the document is imported or checked into the repository. Another kind of linking rule governs what content in a repository a user may link to in a document that will be subsequently checked into the repository. Synchronization rules govern synchronization between content and metadata (or attributes) related to the content. For example, a synchronization rule may specify that whenever a specified CMS attribute is changed, a particular piece of XML in the content should be automatically updated with that attribute's value.

Bursting rules allow an element in a document to be saved as its own chunk (i.e. object or another document) in the CMS so the element may be reused within other documents or managed independently of the containing document(s). These bursting rules are applied automatically by the CMS when a document is imported or checked into the repository or may be applied manually by users during authoring of the document content. In the prior art, when a document is imported or checked into the repository, the document is processed according to one set of bursting rules for the document. The chunks themselves will be stored as individual documents, which may have additional rules associated with them. But those additional rules will not be applied by existing systems. Any additional rules attached to each individual chunk would not get evaluated unless the chunk itself was explicitly edited and checked back into the repository. To have the rules of each chunk evaluated, a user or system administrator would have to check out, edit, and then check in each individual chunk. The chunks may also be reused across grammars or document types. In existing systems, the administrator can define deep bursting rules associated with the top-level (i.e. parent) document to further burst child elements that are multiple levels deep. However, those rules need to be defined for every top-level document type that could directly or indirectly contain similar child element types. It is inefficient and error prone for a system administrator to have to define bursting rules for every top-level document or document type that might contain the chunk of a similar type. This is time consuming, and the user or system administrator may not be aware of all of the chunks that need to have individual content rules evaluated against them. Without a way to autonomically evaluate the rules for each chunk in the repository, the known bursting methods will require manual and error-prone efforts to define and evaluate bursting rules.

### BRIEF SUMMARY

When a document is checked into a content management system repository, the document is processed according to the document's bursting rules. Parts of the document may be stored as separate chunks in the repository. These ‘chunks’ are typically stored as their own individual documents. Each chunk may have a corresponding set of chunk-specific bursting rules and a corresponding child processing policy. The chunks may therefore be further bursted based on rules from the parent document or based on rules associated with the new child chunk document. A granular bursting mechanism processes each chunk in the repository using the applicable bursting rule. One suitable implementation to determine the applicable bursting rule is to recursively decide whether to use the rules for the parent document, or the chunk-specific bursting rules. Another suitable implementation to determine the applicable bursting rule is for each chunk to check the parent document's child processing policy. If the parent document's child processing policy allows specific rules to be overwritten, the chunk-specific bursting rules for the chunk are used. If the parent document's child processing policy does not allow rules to be overwritten, the parent document's bursting rules are used.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a networked computer system that includes a server computer system that has a content management system that includes a granular bursting mechanism;

FIG. 2 is a flow diagram of a prior art method for bursting an original document;

FIG. 3 is a flow diagram of a prior art method for bursting a document that contains chunks from a different parent document;

FIG. 4 is a flow diagram of a method for bursting a document;

FIG. 5 is a flow diagram of a method for one suitable implementation of bursting a document by checking the parent document's child processing policy;

FIG. 6 is a flow diagram of a method for another suitable implementation of bursting a document by recursion;

FIG. 7 is a sample parent XML document;

FIG. 8 shows a sample set of parent bursting rules;

FIG. 9 shows a sample chunk from processing the parent document in FIG. 7 according to the parent bursting rules in FIG. 8;

FIG. 10 shows the sample chunk-specific bursting rules for the chunk in FIG. 9;

FIG. 11 shows a table with values resulting from processing the applicable bursting rule;

FIG. 12 shows the chunk resulting from processing the chunk in FIG. 9 according to the chunk-specific bursting rules in FIG. 10;

FIG. 13 shows the chunk-specific bursting rules for the chunk in FIG. 12; and

FIG. 14 shows a table with values resulting from processing the correct bursting rule.

### DETAILED DESCRIPTION

Many known content management systems use extensible markup language (XML) due to its flexibility and power in managing diverse and different types of content. One known content management system that uses XML is IBM Solution for Compliance in a Regulated Environment (SCORE) developed by IBM Corporation. XML is growing in popularity, and is quickly becoming the preferred format for authoring and publishing. While the disclosure herein discusses XML documents as one possible example of content that may be managed by a content management system, the disclosure and claims herein expressly extend to content management systems that do not use XML.

FIG. 2 shows a prior art method for bursting a document. The document is checked into the repository (step 210). The document is processed according to the bursting rules (step 220) and the document is written to the repository (step 230).

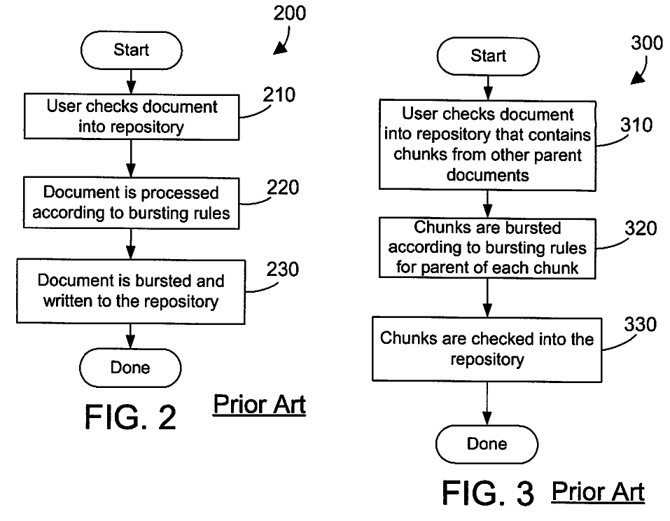

Method 200 shows a prior art method for checking in an original document that was just created that contains no links to existing chunks. If the document being checked in contains links to existing chunks (i.e. which may have originated from other parent documents), then method 300 is applicable. Method 300, shown in FIG. 3, shows a prior art method for bursting a document when the document contains links to existing chunks. The document containing the existing reusable chunks is checked into the repository (step 310). The chunks may then be re-processed according to the bursting rules of the document being checked in (step 320). For example, the content or metadata of the chunks may be updated. Typically, however, once bursted, reusable chunks are not re-processed according to a parent document's bursting rules. The main reason is that after a chunk has been bursted, its reuse context can be unpredictable. If the content or metadata of a chunk is changed in one context (i.e. by a parent document's bursting rules) it may semantically invalidate the chunk when reused in other contexts. The chunks are then checked into the repository (step 330). The prior art methods 200 and 300 apply one set of bursting rules defined for a document to all chunks in the document, even though it may be beneficial to burst different chunks according to different bursting rules.

The granular bursting mechanism disclosed and claimed herein analyzes bursting rules for a document as well as chunk-specific bursting rules for one or more chunks in the document, then determines how to burst or update those chunks when the documents are checked in based on a child processing policy that specifies whether a document's bursting rules may be overridden by chunk-specific bursting rules.

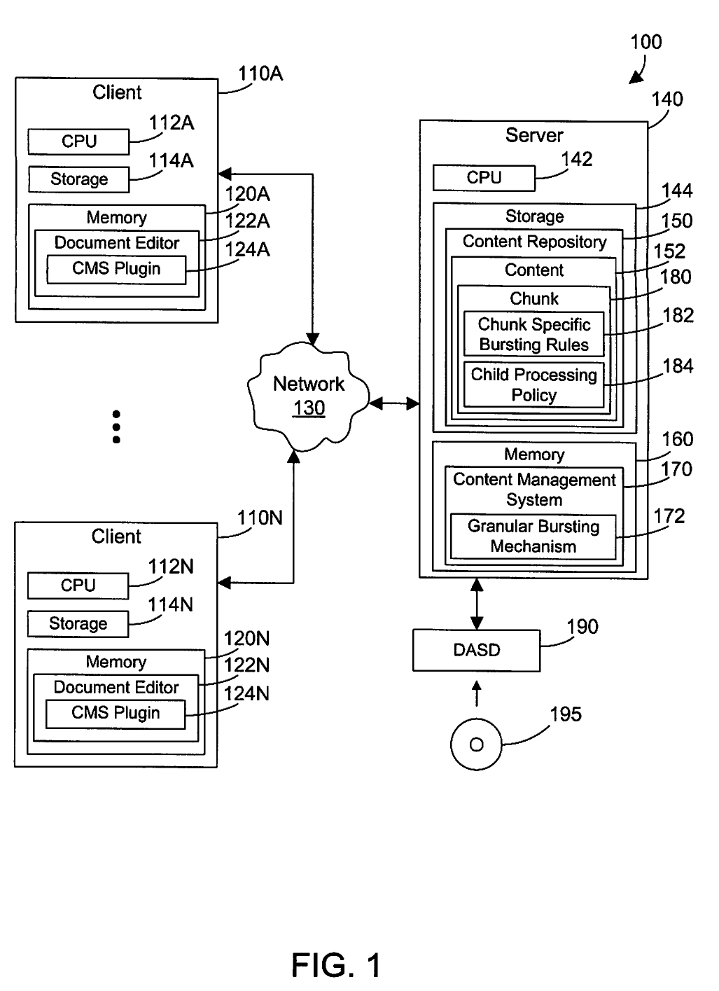

Referring to FIG. 1, networked computer system 100 includes multiple clients, shown in FIG. 1 as clients 110A, . . . , 110N, coupled to a network 130. Each client preferably includes a CPU, storage, and memory that contains a document editor, a content management system (CMS) plugin, and a CMS rule checking mechanism. Thus, client 110A includes a CPU 112A, storage 114A, memory 120A, a document editor 122A in the memory 120A that is executed by the CPU 112A, and a CMS plugin 124A that allows the document editor 122A to interact with content 152 in the repository 150 that is managed by the CMS 170 in server 140. In similar fashion, other clients have similar components shown in client 110A, through client 110N, which includes a CPU 112N, storage 114N, memory 120N, a document editor 122N, and a CMS plugin 124N.

The CMS 170 resides in the main memory 160 of a server computer system 140 that also includes a CPU 142 and storage 144 that includes a content repository 150 that holds content 152 managed by the CMS 170. Content 152 may include one or more chunks 180. As used in the disclosure and claims herein, the term “chunk” means any type of data that may be managed by a content management system, including all known types of data and objects as well as those developed in the future, and the term “element” means any section or portion of a chunk. One example of a suitable server computer system 140 is an IBM eServer System i computer system. However, those skilled in the art will appreciate that the disclosure herein applies equally to any type of client or server computer systems, regardless of whether each computer system is a complicated multi-user computing apparatus, a single user workstation, or an embedded control system. CMS 170 includes granular bursting mechanism 172. Granular bursting mechanism 172 may burst a document into one or more chunks 180. A chunk 180 may include one or more chunk-specific bursting rules 82 and a child processing policy 184 which are discussed in more detail below.

In FIG. 1, repository 150 is shown separate from content management system 170. In the alternative, repository 150 could be within the content management system 170. Regardless of the location of the repository 150, the content management system 170 controls access to content 152 in the repository 150.

Server computer system 140 may include other features of computer systems that are not shown in FIG. 1 but are well-known in the art. For example, server computer system 140 preferably includes a display interface, a network interface, and a mass storage interface to an external direct access storage device (DASD) 190. The display interface is used to directly connect one or more displays to server computer system 140. These displays, which may be non-intelligent (i.e., dumb) terminals or fully programmable workstations, are used to provide system administrators and users the ability to communicate with server computer system 140. Note, however, that while a display interface is provided to support communication with one or more displays, server computer system 140 does not necessarily require a display, because all needed interaction with users and other processes may occur via the network interface.

The network interface is used to connect the server computer system 140 to multiple other computer systems (e.g., 110A, . . . , 110N) via a network, such as network 130. The network interface and network 130 broadly represent any suitable way to interconnect electronic devices, regardless of whether the network 130 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

The mass storage interface is used to connect mass storage devices, such as a direct access storage device 190, to server computer system 140. One specific type of direct access storage device 190 is a readable and writable CD-RW drive, which may store data to and read data from a CD-RW 195.

Main memory 160 preferably contains data and an operating system that are not shown in FIG. 1. A suitable operating system is a multitasking operating system known in the industry as i5/OS; however, those skilled in the art will appreciate that the spirit and scope of this disclosure is not limited to any one operating system. In addition, server computer system 140 utilizes well known virtual addressing mechanisms that allow the programs of server computer system 140 to behave as if they only have access to a large, single storage entity instead of access to multiple, smaller storage entities such as main memory 160, storage 144 and DASD device 190. Therefore, while data, the operating system, and content management system 170 may reside in main memory 160, those skilled in the art will recognize that these items are not necessarily all completely contained in main memory 160 at the same time. It should also be noted that the term “memory” is used herein generically to refer to the entire virtual memory of server computer system 140, and may include the virtual memory of other computer systems coupled to computer system 140.

CPU 142 may be constructed from one or more microprocessors and/or integrated circuits. CPU 142 executes program instructions stored in main memory 160. Main memory 160 stores programs and data that CPU 142 may access. When computer system 140 starts up, CPU 142 initially executes the program instructions that make up the operating system.

Although server computer system 140 is shown to contain only a single CPU, those skilled in the art will appreciate that a content management system 170 may be practiced using a computer system that has multiple CPUs. In addition, the interfaces that are included in server computer system 140 (e.g., display interface, network interface, and DASD interface) preferably each include separate, fully programmed microprocessors that are used to off-load compute-intensive processing from CPU 142. However, those skilled in the art will appreciate that these functions may be performed using I/O adapters as well.

At this point, it is important to note that while the description above is in the context of a fully functional computer system, those skilled in the art will appreciate that the content management system 170 may be distributed as an article of manufacture in a variety of forms, and the claims extend to all suitable types of computer-readable media used to actually carry out the distribution, including recordable media such as floppy disks and CD-RW (e.g., 195 of FIG. 1).

The CMS herein may also be delivered as part of a service engagement with a client corporation, nonprofit organization, government entity, internal organizational structure, or the like. This may include configuring a computer system to perform some or all of the methods described herein, and deploying software, hardware, and web services that implement some or all of the methods described herein. This may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

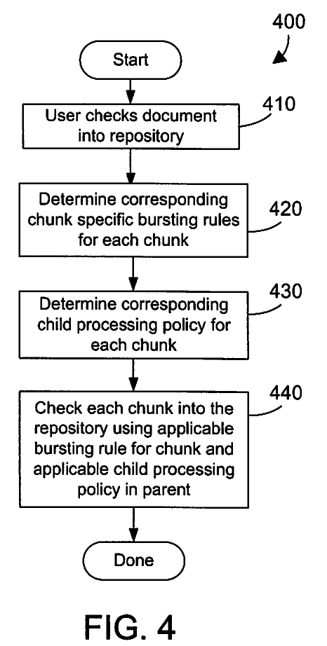

Referring to FIG. 4, method 400 is preferably performed by granular bursting mechanism 172 in FIG. 1. Method 400 begins with a document being checked into the repository (step 410). Next, corresponding chunk-specific bursting rules are determined for each chunk (step 420) and a child processing policy is determined (step 430) for the document and for each chunk in the document. Each chunk is then bursted into the repository using the applicable bursting rule (step 440).

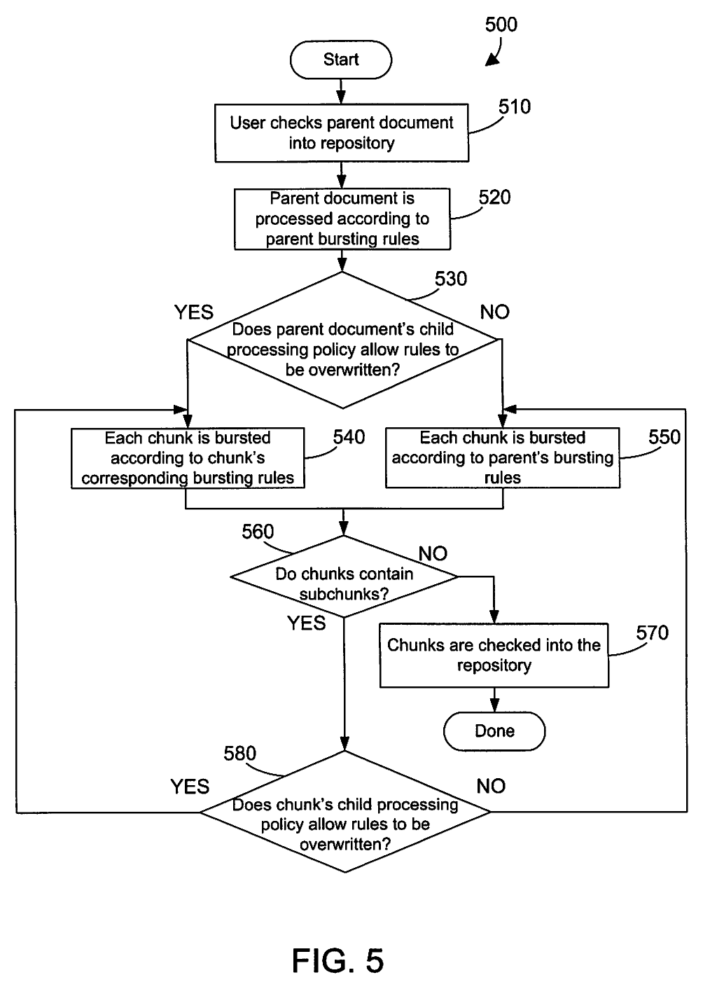

Referring to FIG. 5, a method 500 begins when a user checks a parent document into the repository (step 510). The parent document is then processed according to the parent document's bursting rules (step 520). Note that step 520 identifies chunks in the parent document, but the chunks are not bursted according to the parent document's bursting rules. For each chunk identified in step 520, the parent document's child processing policy is checked, and if the parent document's child processing policy allows rules to be overwritten (step 530=YES), each chunk is bursted according to the chunk's corresponding bursting rules (step 540). If the parent document's child processing policy does not allow rules to be overwritten (step 530=NO), then each chunk is bursted according to the parent document's bursting rules (step 550). Each of the chunks is then checked to see if any of the chunks contains subchunks. If a chunk contains a subchunk (step 560=YES) then method 500 goes to step 580. If the chunk's child processing policy allows rules to be overwritten (step 580=YES), then the subchunk is bursted according to the subchunk's specific bursting rules (step 540) and method 500 returns to step 560. If the chunk's child processing policy does not allow rules to be overwritten (step 580=NO), then the chunk is bursted according to the parent document's bursting rules (step 550), and method 500 returns to step 560. Note the parent document in step 550 refers to the document from which the chunk was bursted. If there are no subchunks in the chunk (step 560=NO), then the chunks are checked into the repository (step 570) and method 500 is done.

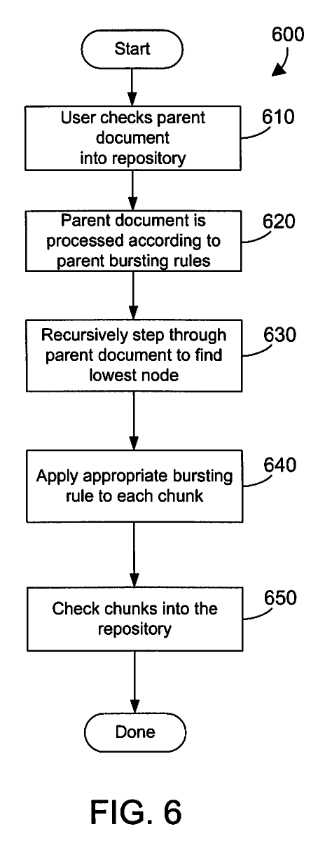

Referring to FIG. 6, a method 600 for a recursive implementation begins with a user checking a parent document into the repository (step 610). The parent document is then processed according to the parent document's bursting rules (step 620). Note that the parent document is processed in step 620 in the same manner as in step 520. The parent document is then stepped through recursively to find the lowest node of each chunk (step 630). The appropriate bursting rule is then applied as each chunk is bursted (step 640), and the appropriate bursting rule is applied recursively up the chain of nodes. The chunks are then checked into the repository (step 650). Note the appropriate bursting rule may be a bursting rule for the chunk, a bursting rule for the chunk's parent, or a bursting rule from any ancestor in the chain of chunks.

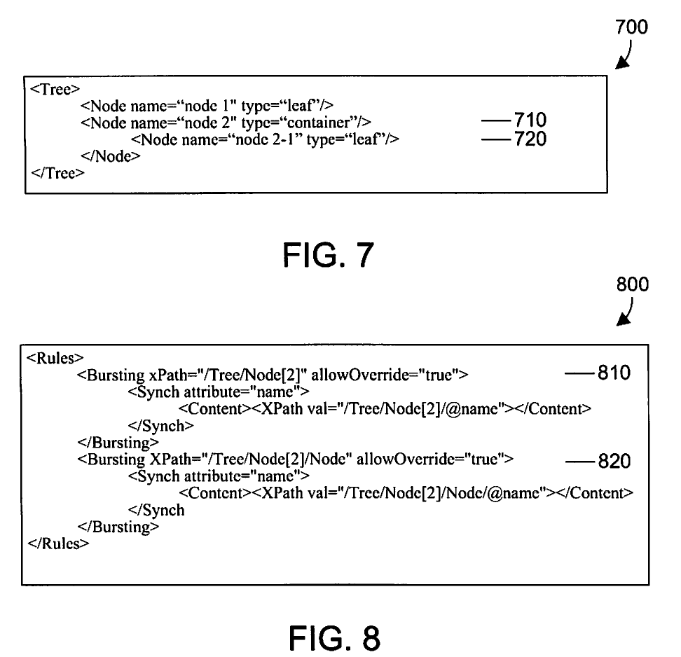

A simple example is now given to illustrate many of the concepts described above. FIG. 7 shows a sample parent XML document 700. FIG. 8 shows a sample set of parent bursting rules 800. For the example herein, the child processing policy is embedded in the text of the parent bursting rules “allowOverride=true” in elements 810 and 820. This is merely one suitable implementation for a child processing policy. Another suitable implementation would be to have a separate child processing policy that resides in memory with each chunk having a corresponding child processing policy.

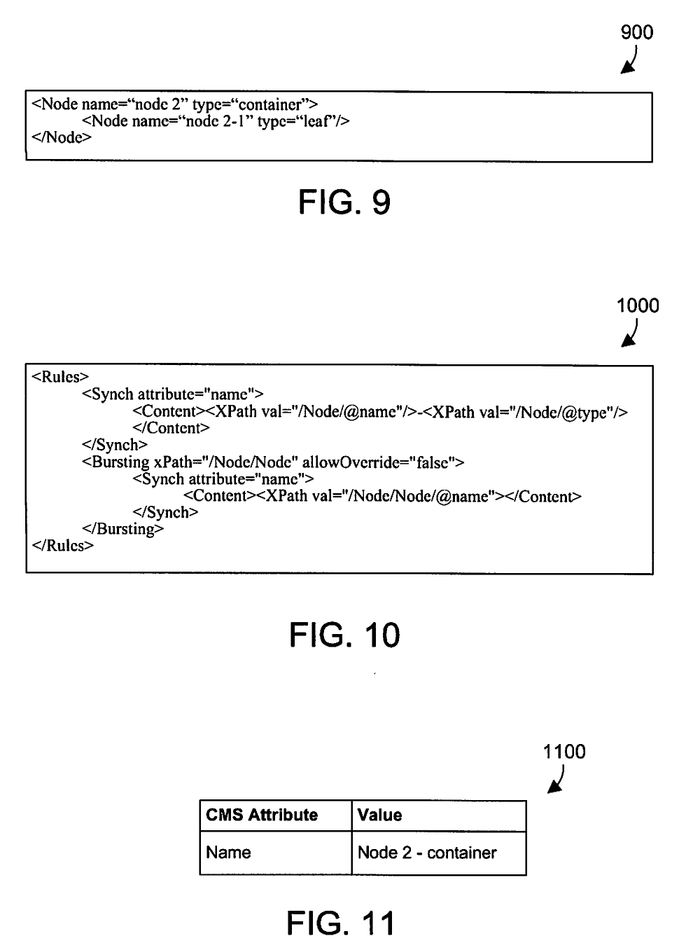

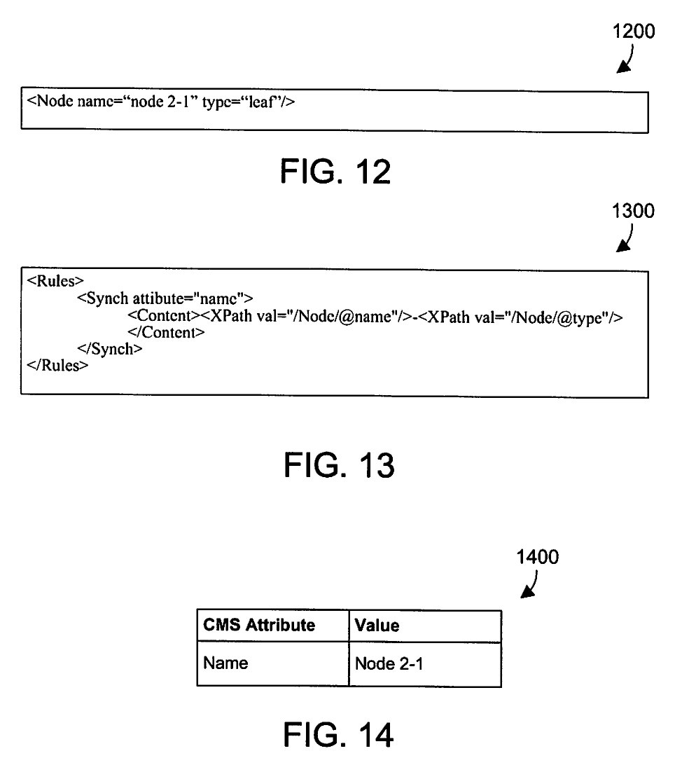

In the example herein, parent document 700 contains portions 710 and 720 that may be individually bursted. Portion 710 is shown as its own XML document (or chunk) 900 in FIG. 9 with corresponding chunk-specific bursting rules 1000 in FIG. 10. Portion 720 is shown as its own XML document (or chunk) 1200 in FIG. 12 with corresponding chunk-specific bursting rules 1300 in FIG. 13. The chunk-specific bursting rules are typically manually defined by a user of the content management system, but the disclosure and claims herein extend to any suitable way to generate chunk-specific bursting rules.

Parent bursting rules 800 shown in FIG. 8 contains two bursting rules 810 and 820. Bursting rule 810 indicates the second <Node> element under the <Tree> element should be bursted into its own chunk, shown as document 900 in FIG. 9. Bursting rule 820 indicates a <Node> element under the second <Node> element under the <Tree> element should be bursted into its own chunk, shown as document 1200 in FIG. 12. Each bursting rule 810 and 820 also contains synchronization rules that indicate how a chunk's CMS metadata is to be updated.

The “allowOverride=true” aspect of bursting rules 810 and 820 indicates to the granular bursting mechanism that bursting rule 810 and 820 may be overridden if a child chunk has a similar rule defined in the child chunk's chunk-specific bursting rules.

We now assume parent document 700 has been checked into the repository by a user (step 510 in FIG. 5). Parent document 700 is then processed according to parent rules 800 in FIG. 8 (step 520 in FIG. 5). The result of parent document 700 being processed according to parent rules 800 is child chunk 900 shown in FIG. 9. Child chunk 900 has corresponding chunk-specific bursting rules 1000 shown in FIG. 10. For the example herein, the corresponding child processing policy for child chunk 900 is embedded within bursting rules 1000. Since parent bursting rules 810 and 820 allowOverride=“true” (step 530=YES in FIG. 5), child chunk 900 is bursted according to chunk-specific bursting rules 1000 (step 540 in FIG. 5). The value resulting from the overwritten synch rule is shown in FIG. 11. FIG. 11 shows the <Name> attribute value was not taken from parent bursting rules 800, but because rules 810 and 820 allowed the rule to be overwritten, the <Name> attribute value came from chunk-specific bursting rules 1000. Child chunk 900 is then checked for subchunks (step 560 in FIG. 5). Since child chunk 900 has a subchunk (step 560=YES in FIG. 5), the child processing policy for child chunk 900 is checked to see if rules can be overwritten (step 580 in FIG. 5). The child processing policy for child chunk 900 is embedded within chunk-specific bursting rules 1000 as allowOverride=“false”. This means that rules cannot be overwritten (step 580=NO in FIG. 5) so the chunk is bursted according to the parent's bursting rules 1000 (step 550 in FIG. 5) as child chunk 1200 shown in FIG. 12. Child chunk 1200 has corresponding chunk-specific bursting rules 1300 shown in FIG. 13. Since child chunk 1200 does not contain any subchunks (step 560=NO in FIG. 5), the chunks are then checked into the repository (step 570).

Since chunk-specific bursting rules 1000 had allowOverride=“false” as the child processing policy, the synch rules for child chunk 1200 were not applied. This is shown in FIG. 14 as the value for the name attribute is assigned from chunk-specific bursting rules 1000, not according to chunk-specific bursting rules 1200. While the example herein is finished, it is understood that steps 540-580 in FIG. 5 are repeated for every chunk resulting from processing the parent document in step 520 of FIG. 5.

The disclosure and claims herein provide a way to determine which bursting rule should be applied to a particular chunk according to bursting rules for a parent document that references the chunk, according to chunk-specific bursting rules, and according to a child processing policy that defines whether bursting rules for a child chunk may override bursting rules for the parent that references the child chunk. In this manner more intelligent bursting decisions may be automatically made.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims. For example, while the examples in the figures and discussed above related to XML documents, the disclosure and claims herein expressly extend to content management systems that handle any suitable type of content, whether currently known or developed in the future. In addition, while the examples herein relate to bursting a single element, the disclosure and claims herein expressly extend to bursting multiple elements, whether multiple elements are bursted to corresponding individual documents in the repository or whether the multiple elements are bursted to a single document in the repository.

1. An apparatus comprising:
at least one processor;
a memory coupled to the at least one processor;
a repository residing in the memory, the repository including a plurality of documents, the plurality of documents including a plurality of chunks;
a first document comprising:
at least one bursting rule for the first document;
a second document comprising:
at least one bursting rule for the second document;
a reference to the first document;
a child processing policy that indicates whether the at least one bursting rule for the second document may be overridden;
a content management system residing in the memory and executed by the at least one processor, the content management system managing the plurality of documents in the repository, the content management system comprising:
a granular bursting mechanism that processes the second document and bursts the first document to the repository during the processing of the second document according to the at least one bursting rule for the second document when the child processing policy indicates the at least one bursting rule for the second document may not be overridden, and bursts the first document during the processing of the second document according to the at least one bursting rule for the first document when the child processing policy indicates the at least one bursting rule for the second document may be overridden.

2. The apparatus of claim 1 wherein, for each chunk in the second document, the granular bursting mechanism determines from the child processing policy for the second document an applicable bursting rule for the second document.

3. The apparatus of claim 1 wherein, for each chunk in the second document, the granular bursting mechanism recursively processes each chunk and any subchunks to determine an applicable bursting rule for each chunk in the second document and to determine an applicable bursting rule for each subchunk.

4. The apparatus of claim 1 wherein each of the plurality of chunks in the repository includes:
at least one chunk-specific bursting rule; and
a child processing policy that indicates whether the at least one chunk-specific bursting rule may be overridden by at least one bursting rule for a subchunk.

5. A computer-implemented method for bursting in a content management system that manages a plurality of documents in a repository, the method comprising the steps of:
storing a first document in a repository, the first document comprising at least one bursting rule for the first document;
storing a second document in the repository, the second document comprising:
at least one bursting rule for the second document;
a reference to the first document;
a child processing policy that indicates whether the at least one bursting rule for the second document may be overridden;
processing the second document and bursting the first document to the repository during the processing of the second document according to the at least one bursting rule for the second document when the child processing policy indicates the at least one bursting rule for the second document may not be overridden, and bursting the first document during the processing of the second document according to the at least one bursting rule for the first document when the child processing policy indicates the at least one bursting rule for the second document may be overridden.

6. The method of claim 5 further comprising the step of:
for each chunk in the second document, determining from the child processing policy for the second document an applicable bursting rule for the second document.

7. The method of claim 5 further comprising the step of:
for each chunk in the second document, recursively processing each chunk and any subchunks to determine an applicable bursting rule for each chunk in the second document and to determine an applicable bursting rule for each subchunk.

8. The method of claim 5 wherein each of the plurality of chunks in the repository includes:
at least one chunk-specific bursting rule; and
a child processing policy that indicates whether the at least one chunk-specific bursting rule may be overridden by at least one bursting rule for a subchunk.

9. A computer-implemented method for bursting in a content management system that manages a plurality of documents in a repository, the plurality of documents including a plurality of chunks, wherein each chunk in the repository includes chunk-specific bursting rules and a child processing policy, the method comprising the steps of:
checking a document that includes a plurality of chunks into the repository, wherein the document further includes document-specific bursting rules and a child processing policy;
for each chunk in the document, performing the steps of:
determining corresponding chunk-specific bursting rules for each chunk;
determining a corresponding child processing policy for each chunk;
checking the document's child processing policy;
if the document's child processing policy allows the document-specific bursting rules to be overwritten, bursting the chunk according to the chunk-specific bursting rules;
if the document's child processing policy does not allow the document-specific bursting rules to be overwritten, bursting the chunk according to the document's document-specific bursting rules; and
checking the chunks into the repository.

10. An article of manufacture comprising:
(A) a content management system comprising:
a granular bursting mechanism that processes a second document that includes:
at least one bursting rule for the second document;
a reference to a first document that includes at least one bursting rule for the first document; and
a child processing policy that indicates whether the at least one bursting rule for the second document may be overridden;
the granular bursting mechanism bursting the first document to the repository during the processing of the second document according to the at least one bursting rule for the second document when the child processing policy indicates the at least one bursting rule for the second document may not be overridden, and bursts the first document during the processing of the second document according to the at least one bursting rule for the first document when the child processing policy indicates the at least one bursting rule for the second document may be overridden; and
(B) recordable media bearing the content management system.

11. The article of manufacture of claim 10 wherein, for each chunk in the second document, the granular bursting mechanism determines from the child processing policy for the second document an applicable bursting rule for the second document.

12. The article of manufacture of claim 10 wherein, for each chunk in the second document, the granular bursting mechanism recursively processes each chunk and any subchunks to determine an applicable bursting rule for each chunk in the second document and to determine an applicable bursting rule for each subchunk.

13. The article of manufacture of claim 10 wherein each of the plurality of chunks in a repository managed by the content management system contains:
at least one chunk-specific bursting rule; and
a child processing policy that indicates whether the at least one chunk-specific bursting rule may be overridden by at least one bursting rule for a subchunk.
